(19) United States
(12) Patent Application Publication
(10) Pub. No.: US 2014/0351092 A1
(43) Pub. Date: Nov. 27, 2014

(54) Methods, Systems, and Media for Marketing Beauty Products and Services

(71) Applicant: Heidi Burkhart, New York, NY (US)

(72) Inventor: Heidi Burkhart, New York, NY (US)

(21) Appl. No.: 14/282,384

(22) Filed: May 20, 2014

Related U.S. Application Data
(60) Provisional application No. 61/825,833, filed on May 21, 2013.

(51) Int. Cl. G06Q 30/06

(52) U.S. Cl. CPC G06Q 30/0625
USPC 705/26.62

(57) ABSTRACT

Methods, systems, and media for marketing beauty products and services are provided. In accordance with some embodiments, systems for marketing beauty products and services are provided, the systems comprising: at least one hardware processor that is configured to: receive a set of credentials associated with a beauty service provider; retrieve, from a database, a profile associated with the beauty service provider in response to receiving the set of credentials; cause the profile associated the beauty service provider to be presented; receive a plurality of images corresponding to a plurality of beauty products; receive at least one video corresponding to creating a makeover using at least one of the plurality of beauty products; receive at least one specialist tip relating to the beauty service provider; and store, in the database, the plurality of images, the video, and the specialist tip in association with the profile associated with the beauty service provider.

### CROSS-REFERENCE TO RELATED APPLICATION

This application claims the benefit of U.S. Provisional Patent Application No. 61/825,833, filed May 21, 2013, which is hereby incorporated by reference herein in its entirety.

### TECHNICAL FIELD

The disclosed subject matter relates to methods, systems, and media for marketing beauty products and services. More particularly, the disclosed subject matter relates to marketing health, fitness, and beauty products and services, such as pet grooming products and services.

### BACKGROUND

A beauty service provider (e.g., a makeup artist, a pet groomer, a hair stylist, a spa, a gym, etc.) may want to interact with potential customers that are interested in beauty products and/or services provided by the beauty service provider via social networking services, history trackers (e.g., past treatments, sessions, etc.), video sharing services, advice sharing media, and/or other platforms. Meanwhile, people who are interested in beauty products and/or services may want to search for beauty service providers that provide interesting products and/or services and to interact with the beauty service providers. Therefore, new mechanisms for marketing beauty products and services and a tool for continuing education for beauty industry are desirable.

### SUMMARY

In accordance with some embodiments of the disclosed subject matter, systems, methods, and media for marketing beauty products and services are provided.

In accordance with some embodiments of the disclosed subject matter, systems for marketing beauty products and services are provided, the systems comprising: at least one hardware processor that is configured to: receive, from a first user device associated with a beauty service provider, a set of credentials associated with the beauty service provider; retrieve, from a database, a profile associated with the beauty service provider in response to receiving the set of credentials, wherein the database stores information about beauty service providers and wherein the beauty service providers comprise specialists and businesses that provide at least one of a beauty product and a beauty service; cause the profile associated the beauty service provider to be presented on the first user device; receive, from the first user device, a plurality of images corresponding to a plurality of beauty products; receive, from the first user device, at least one video corresponding to creating a makeover using at least one of the plurality of beauty products; receive, from the first user device, at least one specialist tip relating to the beauty service provider; store, in the database, the plurality of images, the video, and the specialist tip in association with the profile associated with the beauty service provider; receive, from a second user device associated with a user, a search query including at least one keyword relating to the beauty service provider; identify the beauty service provider based on the received keyword; cause the plurality of images, the video, and the specialist tip to be presented on the second user device; receive, from the second user device, a first image of the user; generate a second image of the user by applying a makeover to the first image using at least one of the plurality of beauty products; and cause the second image to be presented on the second user device.

In accordance with some embodiments of the disclosed subject matter, methods for marketing beauty products and services are provided, the methods comprising: receiving, from a first user device associated with a beauty service provider, a set of credentials associated with the beauty service provider; retrieving, from a database, a profile associated with the beauty service provider in response to receiving the set of credentials, wherein the database stores information about beauty service providers and wherein the beauty service providers comprise specialists and businesses that provide at least one of a beauty product and a beauty service; causing the profile associated the beauty service provider to be presented on the first user device; receiving, from the first user device, a plurality of images corresponding to a plurality of beauty products; receiving, from the first user device, at least one video corresponding to creating a makeover using at least one of the plurality of beauty products; receiving, from the first user device, at least one specialist tip relating to the beauty service provider; storing, in the database, the plurality of images, the video, and the specialist tip in association with the profile associated with the beauty service provider; receiving, from a second user device associated with a user, a search query including at least one keyword relating to the beauty service provider; identifying, using a hardware processor, the beauty service provider based on the received keyword; causing the plurality of images, the video, and the specialist tip to be presented on the second user device; receiving, from the second user device, a first image of the user; generating a second image of the user by applying a makeover to the first image using at least one of the plurality of beauty products; and causing the second image to be presented on the second user device.

In accordance with some embodiments of the disclosed subject matter, non-transitory media containing computer-executable instructions that, when executed by a processor, cause the processor to perform a method for marketing beauty products and services are provided. In some embodiments, the method comprises: receiving, from a first user device associated with a beauty service provider, a set of credentials associated with the beauty service provider; retrieving, from a database, a profile associated with the beauty service provider in response to receiving the set of credentials, wherein the database stores information about beauty service providers and wherein the beauty service providers comprise specialists and businesses that provide at least one of a beauty product and a beauty service; causing the profile associated the beauty service provider to be presented on the first user device; receiving, from the first user device, a plurality of images corresponding to a plurality of beauty products; receiving, from the first user device, at least one video corresponding to creating a makeover using at least one of the plurality of beauty products; receiving, from the first user device, at least one specialist tip relating to the beauty service provider; storing, in the database, the plurality of images, the video, and the specialist tip in association with the profile associated with the beauty service provider; receiving, from a second user device associated with a user, a search query including at least one keyword relating to the beauty service provider; identifying the beauty service provider based on the received keyword; causing the plurality of images, the video, and the specialist tip to be presented on the second user device; receiving, from the second user device, a first image of the user; generating a second image of the user by applying a makeover to the first image using at least one of the plurality of beauty products; and causing the second image to be presented on the second user device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify the like elements.

FIG. 1 shows an example of a user interface for receiving a search query for beauty products and/or services in accordance with some embodiments of the disclosed subject matter.

FIG. 2 shows an example of a user interface for receiving a search query for beauty specialists in accordance with some embodiments of the disclosed subject matter.

FIG. 3 shows an example of a user interface for presenting search results in response to a search query for beauty service providers in accordance with some embodiments of the disclosed subject matter.

FIG. 4 shows an example of a user interface for searching for beauty service providers in accordance with some embodiments of the disclosed subject matter.

FIG. 5 shows an example of a user interface for creating a user profile in accordance with some embodiments of the disclosed subject matter.

FIG. 6 shows an example of a user interface for receiving user credentials in accordance with some embodiments of the disclosed subject matter.

FIG. 7 shows an example of a user interface for prompting a beauty service provider to provide user information in accordance with some embodiments of the disclosed subject matter.

FIG. 8 shows an example of a user interface for presenting information about a user account in accordance with some embodiments of the disclosed subject matter.

FIG. 9 shows an example of a user interface for presenting notifications to a user in accordance with some embodiments of the disclosed subject matter.

FIG. 10 shows an example of a user interface for facilitating client management in accordance with some embodiments of the disclosed subject matter.

FIG. 11 shows an example of a user interface for prompting a user to provide specialists' tips in accordance with some embodiments of the disclosed subject matter.

FIG. 12 shows an example of a user interface for prompting a user to provide information for a specialist account in accordance with some embodiments of the disclosed subject matter.

FIG. 13 shows an example of a user interface for receiving information about a business account from a beauty provider in accordance with some embodiments of the disclosed subject matter.

FIG. 14 shows an example of a user interface for presenting general information about a user account in accordance with some embodiments of the disclosed subject matter.

FIG. 15 shows an example of a user interface for presenting videos relating to a user account in accordance with some embodiments of the disclosed subject matter.

FIG. 16 shows an example of a user interface for presenting updates relating to a user account in accordance with some embodiments of the disclosed subject matter.

FIG. 17 shows an example of a user interface for presenting customer reviews relating to a user account in accordance with some embodiments of the disclosed subject matter.

FIG. 18 shows an example of a user interface for presenting information about specialists relating to a user account in accordance with some embodiments of the disclosed subject matter.

FIG. 19 shows an example of a user interface for presenting client information relating to a user account in accordance with some embodiments of the disclosed subject matter.

FIG. 20 shows a generalized schematic diagram of an example of a system for marketing beauty products and/or services in accordance with some embodiments of the disclosed subject matter.

FIG. 21 shows a flow chart of an example of a process for marketing beauty products and/or services in accordance with some embodiments of the disclosed subject matter.

### DETAILED DESCRIPTION

In accordance with some embodiments, mechanisms for marketing beauty products and services are provided. Generally speaking, these mechanisms can include a web and/or mobile application that can allow users of the application to create an account with the application, communicate with other users, conduct searches relating to the beauty industry, browse and purchase products and/or services, share makeover stories with other users, market beauty products and/or services, etc.

As referred to herein, a beauty service provider can be any suitable individual and/or entity that can provide beauty products and/or services. For example, a beauty service provider can be a specialist, such as a pet groomer, a hair stylist, a makeup artist, a laser therapy specialist, a massage therapist, an esthetician, a nail technician, a fitness trainer, and/or any other suitable specialist that can provide beauty products and/or service. As another example, a beauty service provider can be a business, such as a spa, a beauty salon, a gym, a hair salon, a fitness center, a barber shop, and/or any other suitable business that can provide beauty products and/or services.

In some embodiments, the mechanisms can store information relating to beauty services and/or products associated with a user (e.g., a beauty service provider such as a specialist and/or a business, a client of a beauty service provider, and/or any other suitable user), communications with other users, and/or any other suitable information relating to the user. For example, the mechanisms can store information relating to past treatments, sessions, and/or any other suitable services and/or products provided to a user and can present the stored information to the user in response to a request for such information. As another example, the mechanisms can store a history of treatments, sessions, and/or any other suitable services and/or products that have been provided to the clients of a user (e.g., a beauty service provider). In a more particular example, the mechanisms can store any suitable information relating to services and/or products provided to a specific client, such as information relating to a specialist that provided the service and/or product to the client, the treatment provided to the client, the date of the treatment and/or any other suitable information relating to services and/or products provided to the client.

In some embodiments, information relating to a given past treatment and/or session can be presented to a client that received the treatment and/or session, a specialist that provided the treatment and/or session, a business that is associated with the specialist, and/or any other suitable user associated with the treatment and/or session. In some embodiments, information relating to treatments, sessions, and/or any other suitable services and/or products that have been provided to a user and/or a user's clients can be indexed and stored by client, specialist, business, and/or any other suitable criterion or criteria. In some embodiments, the mechanisms can retrieve stored information relating to past treatments and/or sessions in response to receiving a search query for such information from a user (e.g., a client, a specialist, a business, and/or any other suitable user). In some embodiments, information relating to past treatments and/or sessions can be searched by client, specialist, beauty business, and/or any other suitable criterion or criteria.

In some embodiments, the application can allow a user to create an account by entering suitable information about the user, the user's business, the products and/or services provided by the user and/or the user's business, etc. In some embodiments, the application can receive permission to share some or all of the information about the user's account with other users. For example, the user can choose to share the user's photos, contact information, specialty, employment history, information about the user's appointments with one or more specialists and/or businesses, etc. with other users. In a more particular example, the shared information can be included in an electronic business card, such as a VCARD.

In some embodiments, in response to the user granting permission to share information about the user and/or the user's account with other users, the application can encode the information into a suitable barcode, such as a one-dimensional code, a two-dimensional code, a Universal Product Code (UPC), a quick response (QR) code, etc. In some embodiments, the user can receive information about one or more other users' accounts (e.g., such as another user's profile, products, services, business, etc.) by scanning a barcode containing such information using a suitable user device (e.g., a mobile phone with a camera).

In some embodiments, the application can allow the user to conduct a search for specialists, businesses, etc. using suitable search terms. For example, the application can allow the user to search for specialists and/or businesses that provide particular products and/or services. As another example, the application can allow the user to search for particular specialists based on information about the licenses held by the specialists, the specialist' employment history, etc. As yet another example, the application can allow the user to locate specialists and/or businesses based on the user's location (e.g., using a suitable GPS device). In some embodiments, the application can allow the user to link the user's account with one or more of the user's social media accounts (e.g., such as FACEBOOK, LINKEDIN, TWITTER, YOUTUBE, etc.).

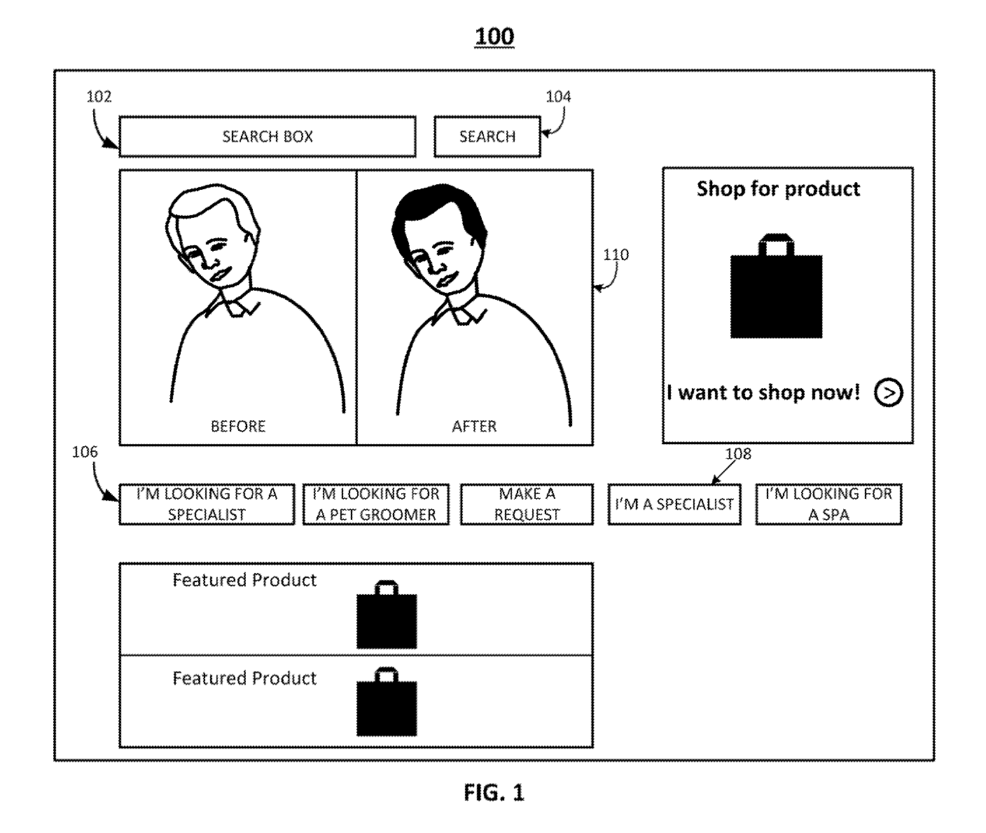

These and other features for marketing beauty products and/or services are described by way of the examples shown in FIGS. 1-21.

In some embodiments, once loaded on a user device (e.g., a computer, a mobile phone, and/or any other suitable user device including a hardware processor), the application can present a user with multiple interfaces. For example, as illustrated in FIG. 1, an interface 100 can be presented to a user. As shown, interface 100 can include a search term entry field 102 and a search button 104. Search term entry field 102 can be any suitable field for entering search terms for searching for beauty products and/or services in accordance with some embodiments. For example, as shown, field 102 can be a text entry box for receiving typed text. Search button 104 can be any suitable mechanism for receiving an indication from a user that a search can be performed in accordance with some embodiments. In some embodiments, in response to the user selecting search button 104, the application can perform a search for the beauty products and/or services relating to the search terms entered in filed 102.

In some embodiments, interface 100 can include a display area 110 that can be used to prompt a user to upload, view, and/or edit text, photos, videos, etc. about makeovers (e.g., by applying makeup, haircuts, etc.). For example, the user can upload photos of the user's appearances prior to and after a Do It Yourself (DIY) makeup, respectively. As another example, the user can view text, photos, videos, etc. uploaded by other users using interface 100. As yet another example, the user can make comments about the beauty stories and/or specialists' tips posted by other users or the user using interface 100. In some embodiments, the user can upload photos and/or videos using a suitable user device that is equipped with one or more cameras.

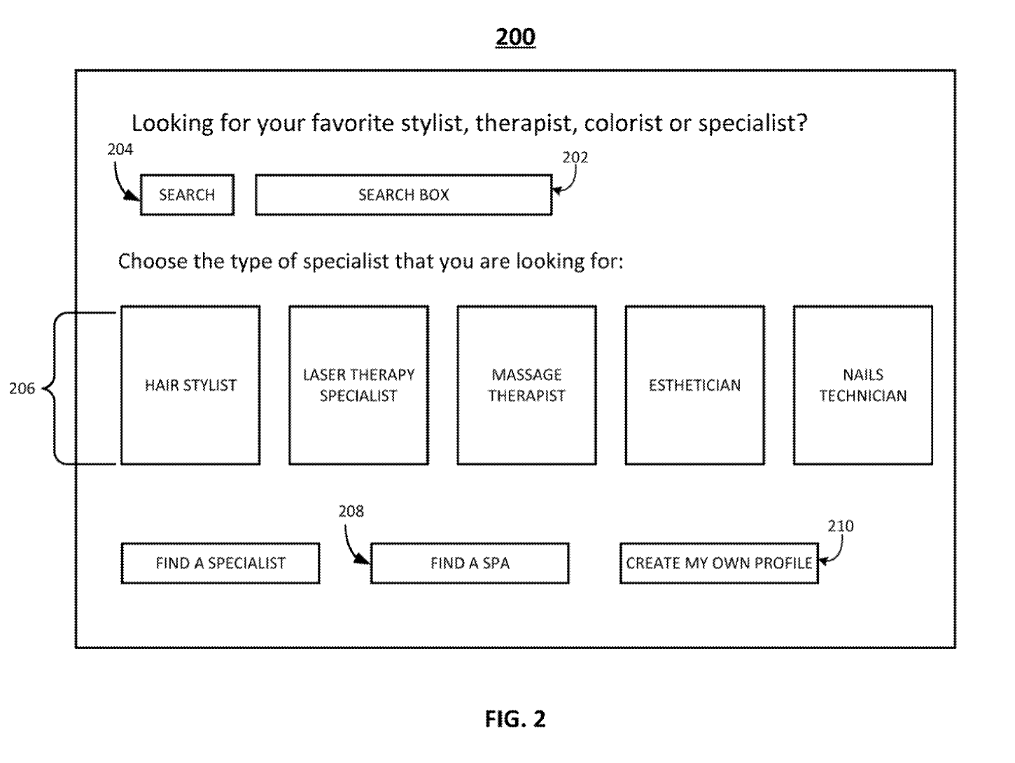

In some embodiments, interface 100 can also include a button 106 that can allow the user to initiate a search for one or more specialists who can provide particular beauty products and/or services. Examples of the specialists can include pet groomers, fitness trainers, hair stylists, makeup artists, laser therapy specialists, massage therapists, estheticians, nails technicians, etc. In some embodiments, in response to receiving a user input indicating that a search for one or more specialists should be performed (e.g., a user selection of button 106 of interface 100), the application can cause a user interface 200 as shown in FIG. 2 to be presented to allow the user to locate one or more particular specialists. As shown, interface 200 can include a search term entry field 202 and a search button 204. The user can enter any suitable search terms in field 202. For example, the search terms can include the names of the one or more specialists, information about the specialists' past employment, information about the license(s) held by the specialists, the locations of the specialists, the language spoken by the specialists, the specialty of the specialists (e.g., pet groomers, fitness trainers, hair stylists, laser therapy specialists, massage therapists, estheticians, nails technicians, etc.), etc. In some embodiments, after entering suitable search terms in field 202, the user can select search button 204 to start a search. In some embodiments, in response to the user indicating that a search for one or more particular specialists should be performed (e.g., by selecting search button 204 of interface 200), the application can perform a search for specialists based on the search terms entered in field 202.

In some embodiments, the application can provide the user with various options to narrow down the search results generated when searching for the search terms entered in field 202. For example, the application can prompt the user to identify a type of specialists that the user intends to find. The application can then perform a search for specialists of the selected type. In a more particular example, as illustrated in FIG. 2, interface 200 can include a set of buttons 206, each of which can correspond to a particular type of specialist (e.g., such as hair stylists, laser therapy specialists, massage therapists, estheticians, nails technicians, etc.). In some embodiments, for example, the user can identify a particular type of specialist that the user is looking for by selecting the button corresponding to the particular type of specialist. In response to the user identifying the particular type of specialist, the application can perform a search and return search results of specialists of the identified type. In some embodiments, the application can perform a search and return search results of particular specialists (e.g., pet groomers, fitness trainers, makeup artists, and/or any other suitable specialists) and/or businesses (e.g., spas, gyms, and/or any other suitable businesses) based on the search terms entered in field 202 and the one of the set of buttons 206 selected by the user.

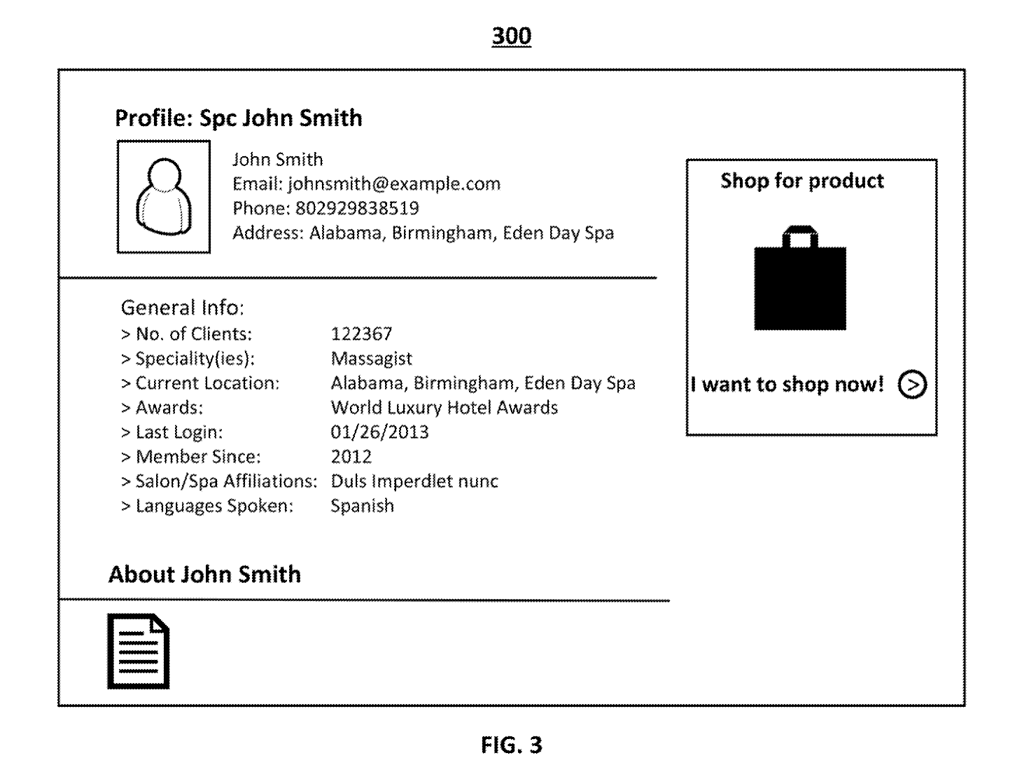

In some embodiments, upon performing a search for specialists based on the user's search terms, the application can present the search results to the user. The search results can include any suitable information and that information can be presented in any suitable manner. For example, in some embodiments, such information can be presented using text, graphics, images, video, sounds, audio, etc. In a more particular example, as illustrated in FIG. 3, such information can be presented to the user using an interface 300. As shown, interface 300 can include any suitable information about one or more specialists included in the search results. More particularly, for example, interface 300 can present to the user one or more photos of the specialists, the names of the specialists, the contact information (e.g., phone numbers, addresses, email accounts, etc.) of the specialists, general information about the specialists (e.g., the number of clients, specialties, licenses held by the specialists, awards earned by the specialists, language spoken by the specialists, etc.), and/or any other suitable information.

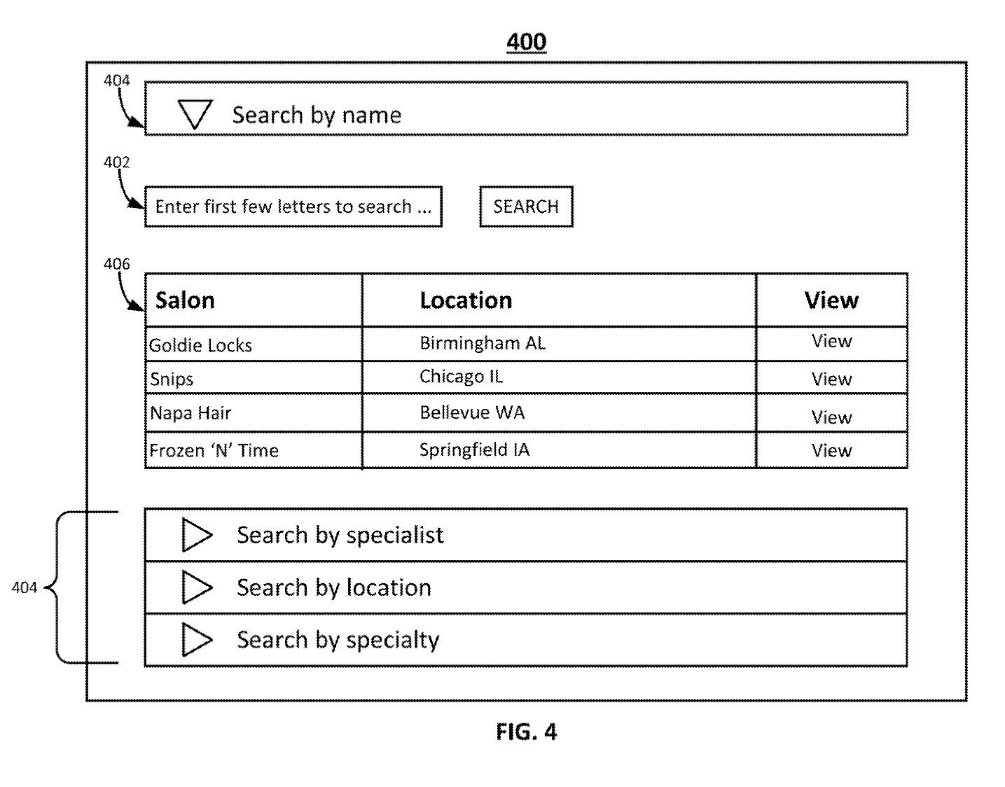

In some embodiments, the application can allow the user to search for a beauty business that provides particular beauty products and/or services, such as a spa, a beauty salon, a hair salon, a fitness center, etc. For example, as illustrated in FIG. 3, the user can select button 208 of interface 200 to initiate a search for a beauty business. In some embodiments, in response to the user indicating that a search for one or more beauty businesses should be performed, an interface 400 as illustrated in FIG. 4 can be presented to the user. As shown, interface 400 can include a search field 402 that can be used to enter one or more suitable search terms (e.g., such as the name of the beauty business, information about one or more specialists associated with the beauty business, the location of the beauty business, the specialty of the beauty business, etc.) to locate one or more particular beauty businesses in response to the search terms. In some embodiments, the application can allow the user to locate one or more beauty businesses in a particular location. For example, the application can identify the user's geolocation using a suitable GPS device and search for the beauty businesses based on the user's geolocation and/or the search terms entered by the user. As another example, the application can allow the user to locate beauty businesses that are newly opened based on the user's geolocation. In some embodiments, interface 400 can also include one or more suitable filter options 404. The filter options can include any suitable mechanisms, such as a drop down menu, for receiving the user's selection of any suitable one or more filters to be applied to search results in accordance with some embodiments. For example, the user can select one or more particular filter options to search for beauty businesses by their names, specialists, locations, specialties, etc. In a more particular example, as illustrated in FIG. 4, in response to receiving a user input indicating a search for beauty businesses should be performed by name (e.g., by selecting the search by name button of interface 400), the application can present to the user a list of beauty businesses 406 whose names relate to the search terms entered by the user. In some embodiments, the application can limit the search results to beauty businesses having names relating to the search terms entered by the user.

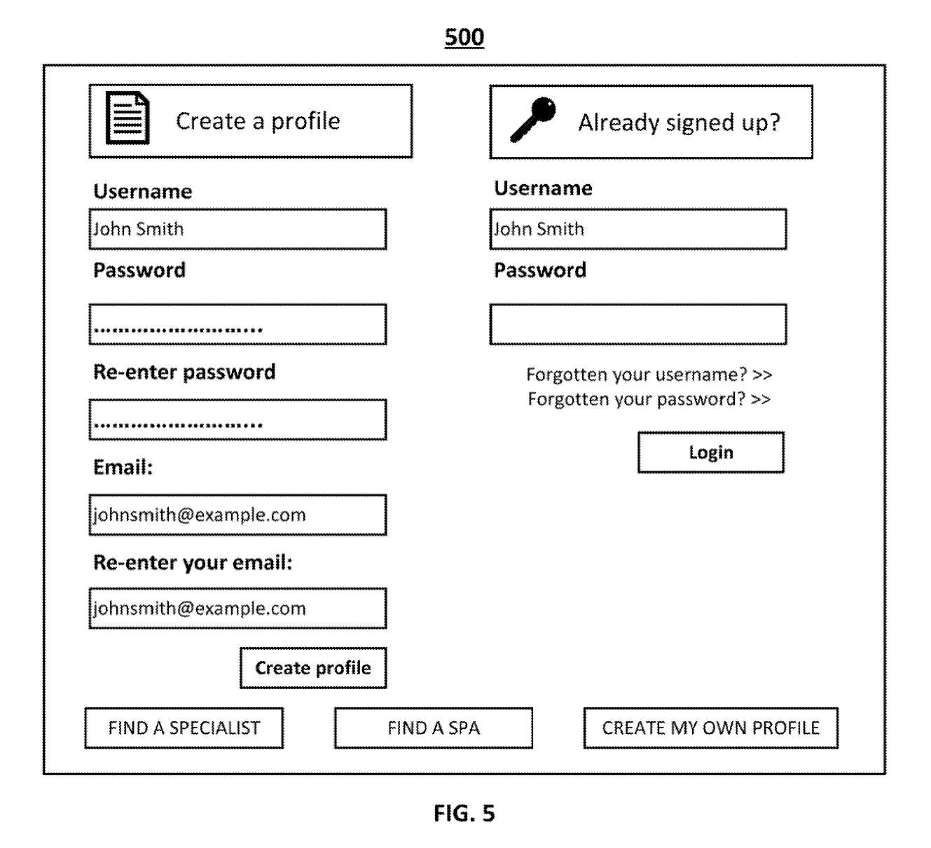

In some embodiments, the application can prompt the user to set up an account using the application. For example, as shown in FIG. 2, the user can select button 210 of interface 200 to create a new account. In response to the user initiating the creation of a new account, the application can set up an account for the user in any suitable manner. For example, the application can present one or more suitable interfaces to the user to allow the user to enter suitable information about the user and/or the use's account. In a more particular example, an interface 500 as illustrated in FIG. 5 can be presented to the user in accordance with some embodiments. As shown, interface 500 can allow the user to create a new account by creating a profile for the user. For example, the user can create a profile by entering a user name, a password, an email address, and/or any other suitable information.

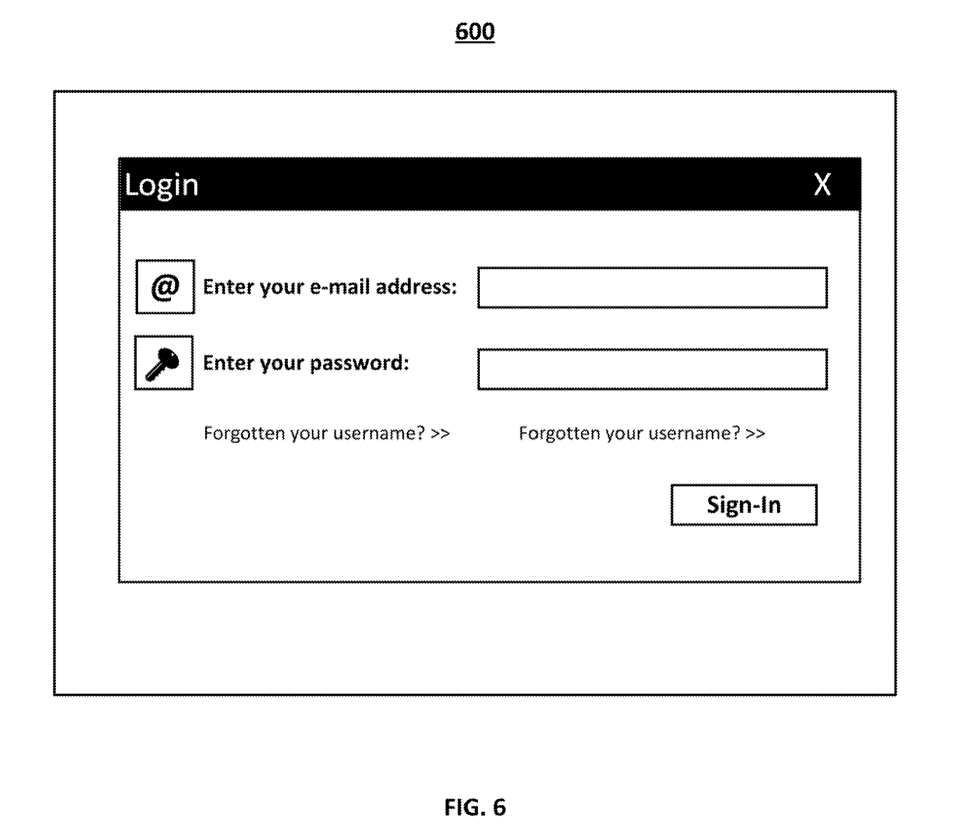

In some embodiments, the application can allow the user to log into the user's account using suitable user credentials. For example, as illustrated in FIGS. 5 and 6, the application can prompt the user to log into the user's account using the user's user identification, email address, password, etc. in the case where an account has been created for the user.

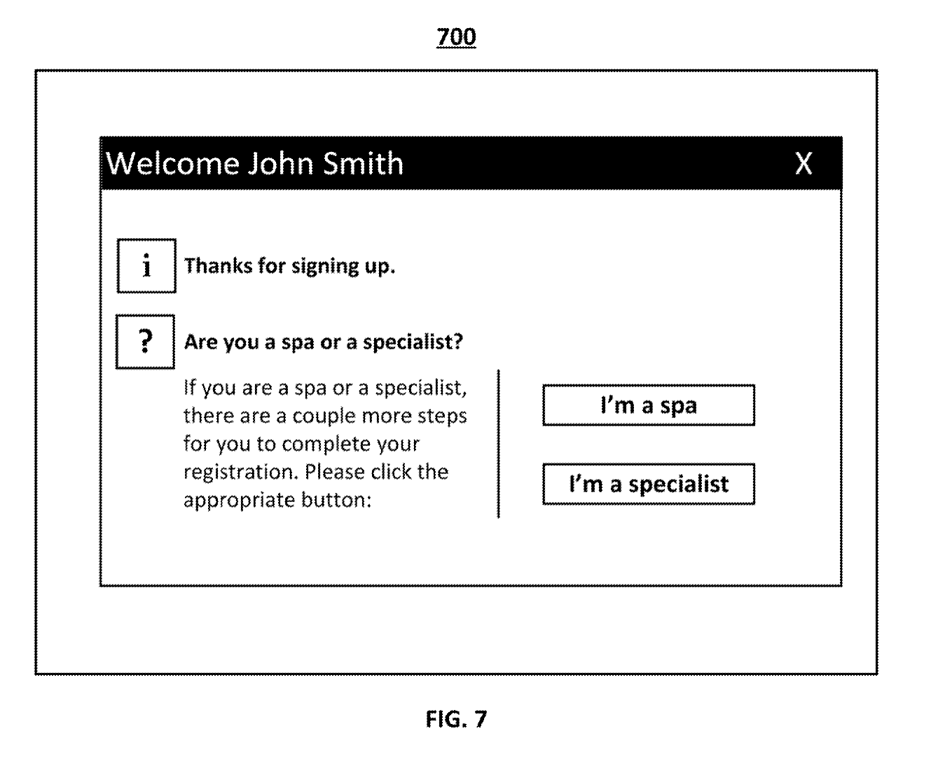

In some embodiments, in response to the user entering suitable information to create a profile, the application can prompt the user to provide additional information about the user. For example, as illustrated in FIG. 7, the application can present an interface 700 to the user to prompt the user to provide more information about the user. As shown, interface 700 can include a message window that can allow the user to create a business account or a specialist account by indicating that the user is a business or a specialist, respectively.

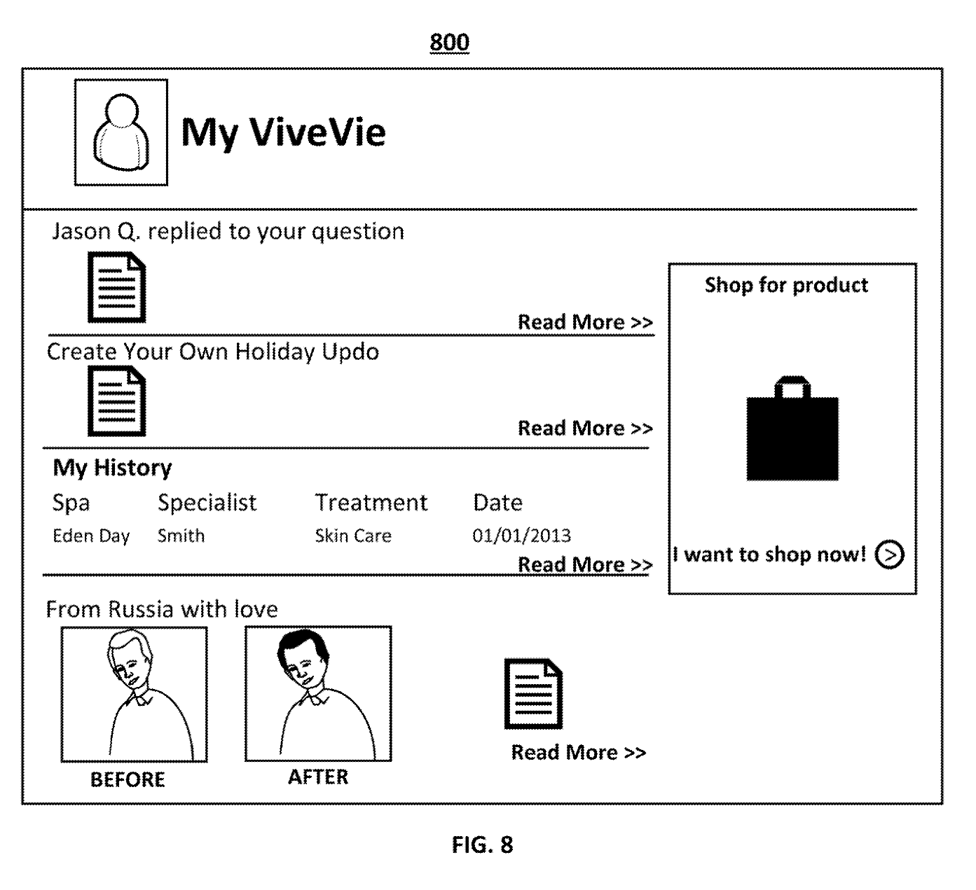

In some embodiments, the user can close the message window shown on interface 800 to indicate that the user is neither a business nor a specialist. In response to the user closing the message window, the application can allow the user to browse and/or edit information about the user's account using one or more suitable interfaces. For example, as illustrated in FIG. 8, an interface 800 can be presented to the user in some embodiments. Interface 800 can include any suitable information about the user's account. For example, as shown, interface 800 can include messages, posts, and/or other correspondences sent by other users. As another example, interface 800 can include information relating to past treatments, sessions, and/or any other suitable products and/or services provided to the user, such as a description of the treatment, a description of the specialist that provided the treatment, a beauty service provider (e.g., a spa, a gym, etc.) that is associated with the specialist, and/or any other suitable information. As yet another example, interface 800 can allow the user to upload text, images, videos, etc. relating to any suitable topics to the user's account. In a more particular example, the user can upload text, images and/or videos for a person's appearances prior to and after a makeover (e.g., by applying makeup, hair coloring, etc.). More particularly, for example, the makeover can relate to applying one or more makeup techniques, such as applying eyelashes, eyeliners, etc. In another more particular example, the user can upload an image of the user's appearance prior to a makeover using the application. The user can then create one or more appearances by applying one or more makeovers using the application. In some embodiments, the application can generate images and/or videos relating to the user's appearances after applying such makeovers.

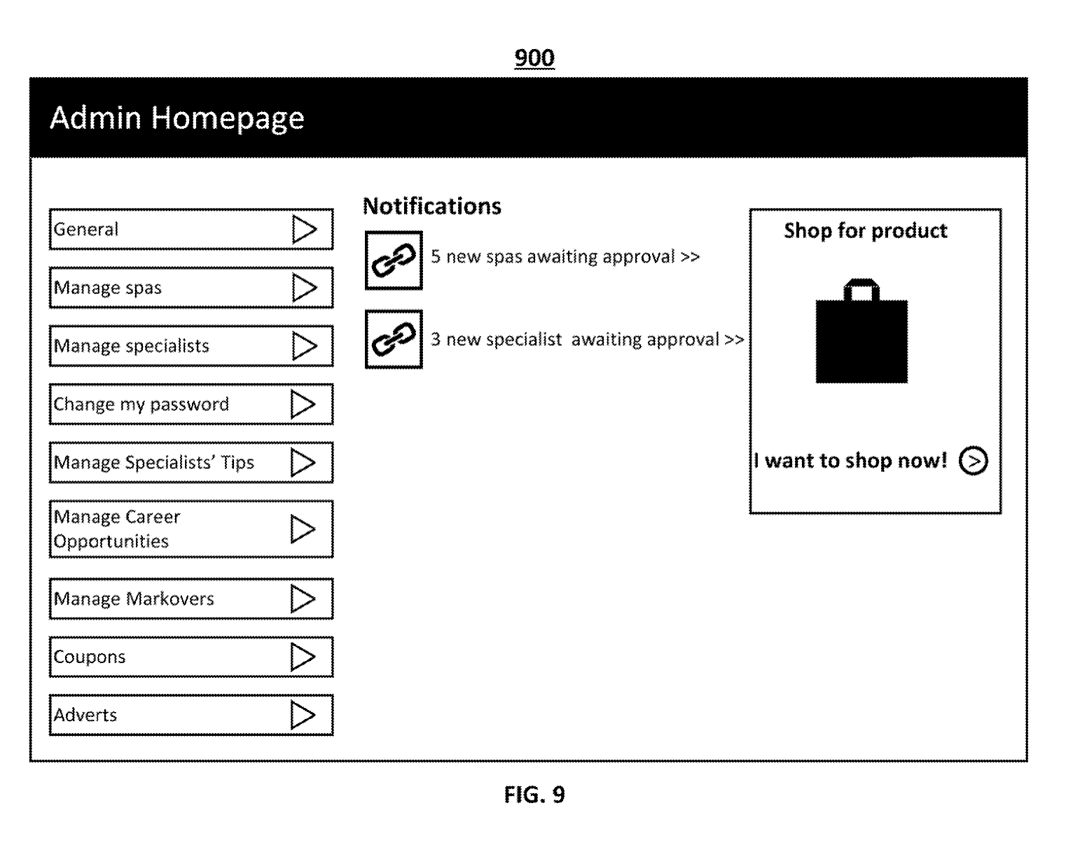

In some embodiments, the application can allow the user to receive and/or view notifications from other users. For example, as illustrated in FIG. 9, an interface 900 can be presented to the user to view such notifications. The notifications can include any suitable information. For example, the notifications can include information about the services and/or products offered by a specialist and/or a beauty business, information about a newly established beauty business, etc.

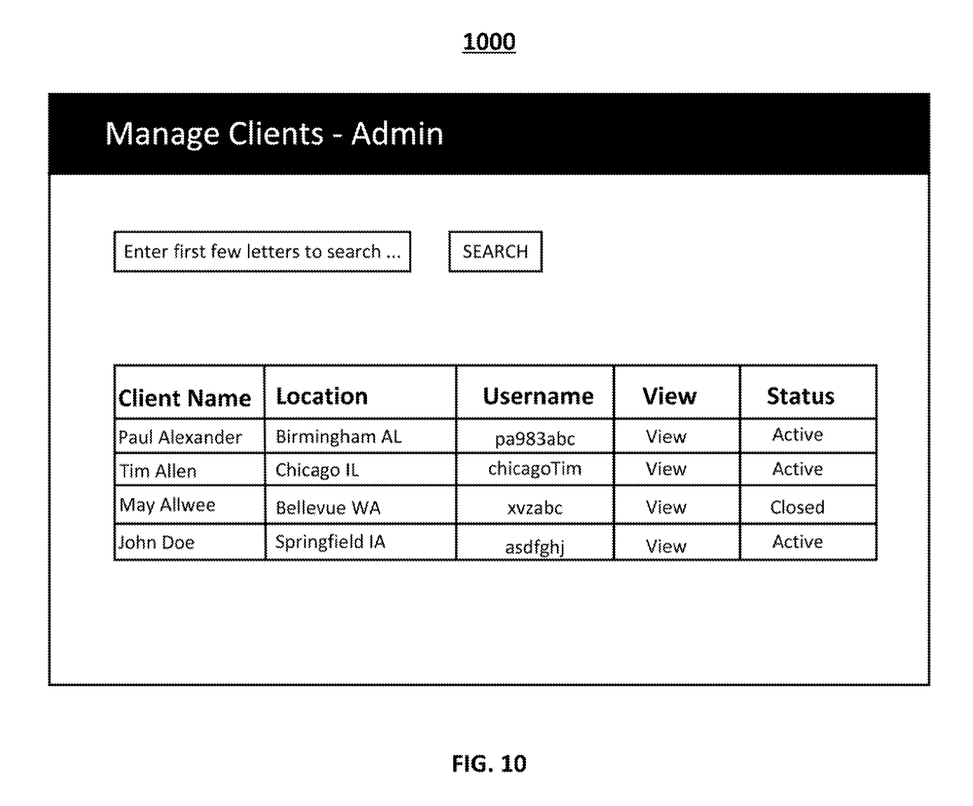

In some embodiments, the application can allow the user to manage information about the user's clients. For example, as illustrated in FIG. 10, an interface 1000 can be presented to the user to facilitate management of information about the user's clients. As shown, interface 1000 can include any suitable information about one or more of the user's clients, such as the name of each client, the location of each client, the user name of each client, the status of each client's account (e.g., active, inactive, etc.), etc. In some embodiments, the user can select one or more clients listed on interface 1000 to view more information about the selected client, such as the products and/or services purchased by the selected client, publication information about the user's account, etc. In some embodiments, the application can allow the user to extract any suitable information about the user's clients into one or more EXCEL spreadsheets.

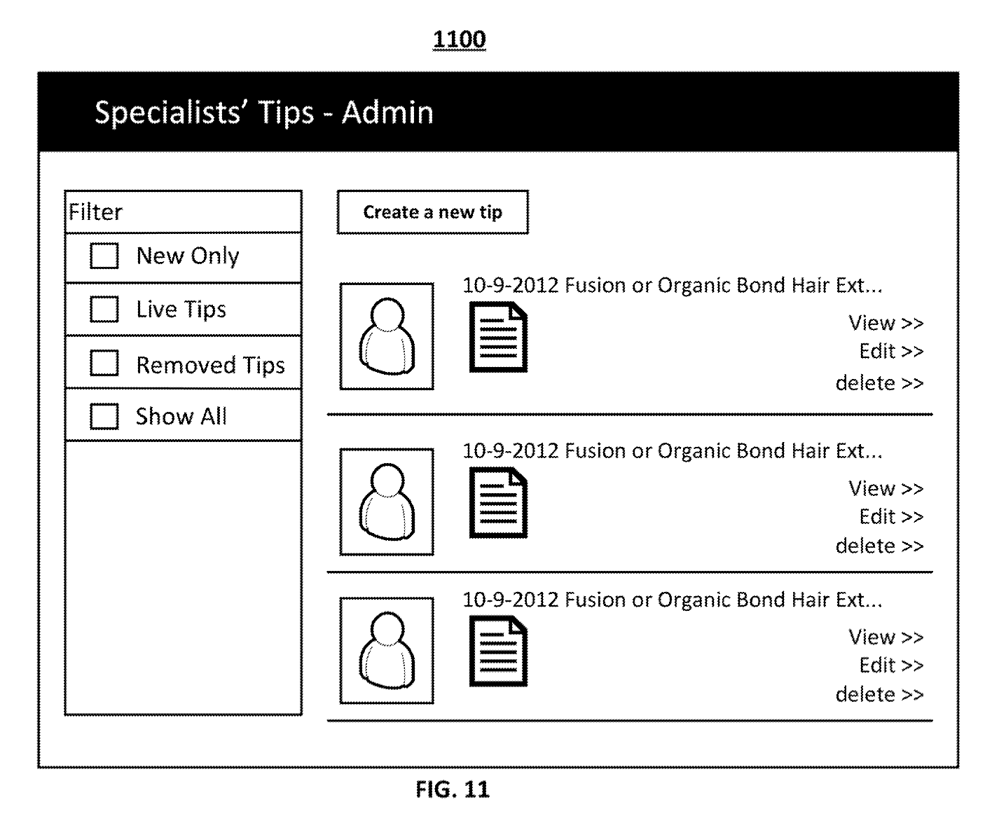

In some embodiments, the application can allow the user to view, edit, and/or upload specialists' tips relating to the user's products, services, business, etc. For example, as illustrated in FIG. 11, an interface 1100 can be presented to the user to allow the user to create, edit, view, and/or upload text, images, and/or videos about specialists' tips. The specialists' tips can relate to any suitable topics, such as beauty products, beauty services, makeup techniques (e.g., how to apply different types of eye lashes), haircut styles, etc.

In some embodiments, a user can connect to other users via the application. For example, the user can select one or more specialists (e.g., pet groomers, fitness trainers, hair stylists, and/or any other suitable specialist) and/or businesses (e.g., spas, gyms, and/or any other suitable businesses) that can provide beauty products and/or services. The user can then connect to the selected specialists and/or businesses by following and/or subscribing to the selected specialists and/or businesses and/or in any other suitable manner. In some embodiments, content associated with the selected specialists and/or businesses (e.g., specialist tips, posts, notes, news feeds, images, videos, makeover submissions, and/or any other suitable content associated with the specialists and/or businesses) can be presented to the user in any suitable manner. For example, content associated with a given specialist and/or business can be presented to the user in response to the user requesting the content (e.g., by going to a Web site associated with one or more of the selected specialists and/or businesses). As another example, content associated with one or more of the selected specialists and/or businesses can be presented to the user as a feed of content by email, text message, mobile notification, and/or any other suitable mechanism.

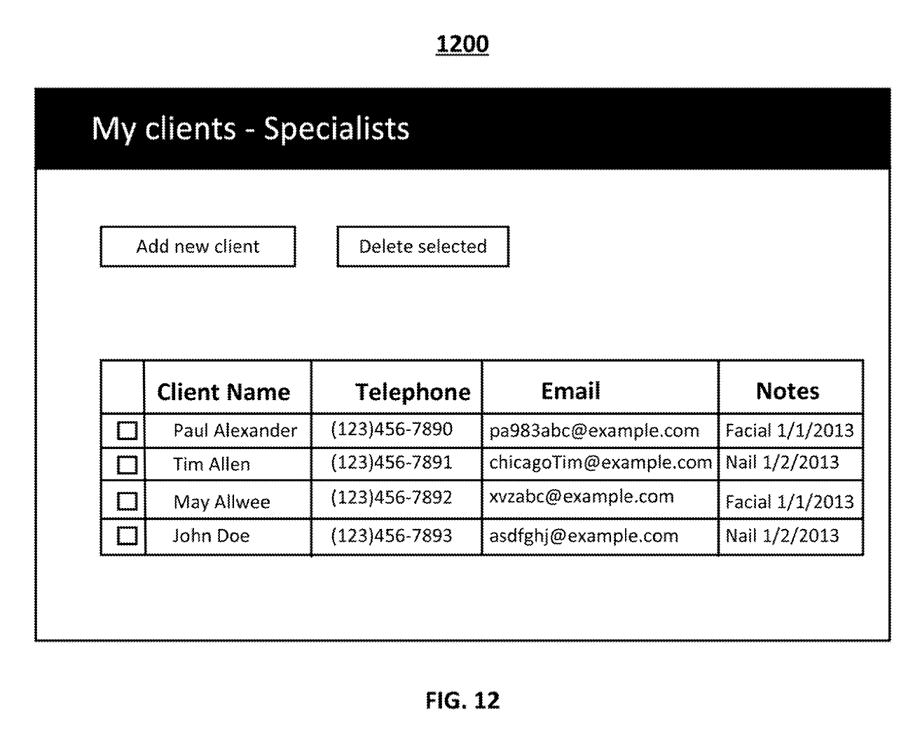

In some embodiments, in response to the user indicating that the user is a specialist (e.g., using interface 700 of FIG. 7), the application can present one or more suitable interfaces to the user to allow the user to set up a specialist account. For example, as illustrated in FIG. 12, an interface 1200 can be presented to the user to allow the user to provide additional information for the user's specialist account. As shown, the user can edit information about the user's clients using interface 1200. For example, the user can view and/or add information about one or more clients. In a more particular example, the user can enter the names, the telephone numbers, the email addresses of the new clients, and/or any other suitable information relating to the clients. In another more particular example, the user can view and/or add comments and/or notes relating to treatments, sessions, and/or any other suitable beauty services and/or products that have been provided to each of the clients. As another example, the user can delete information about one or more clients from the user's account using interface 1200. In a more particular example, the user can select one or more clients on interface 1200 and delete the information about the selected clients by selecting the “delete selected” button of interface 1200.

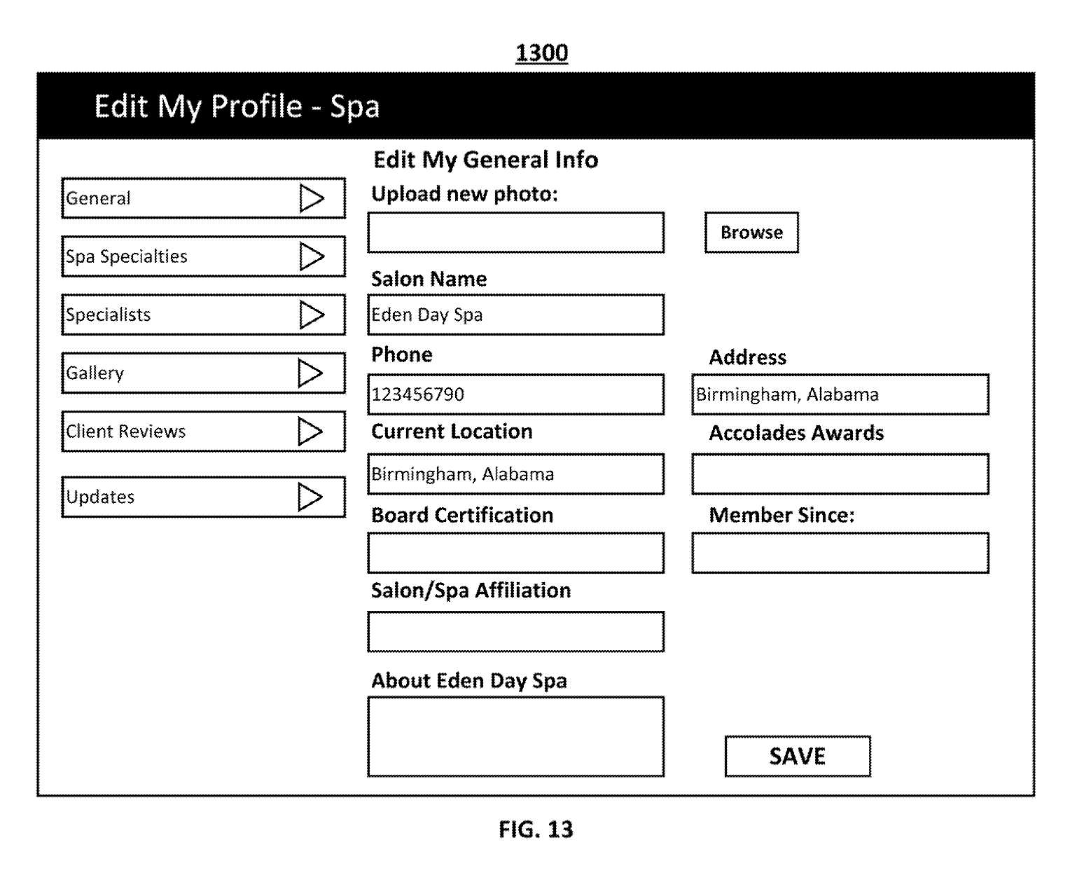

In some embodiments, in response to the user indicating that a business account should be established for the user (e.g., using interface 700 of FIG. 7), the application can set up a business account for the user. For example, as shown in FIG. 13-16, the application can present the user with multiple interfaces to allow the user to provide suitable information about the user's business.

In some embodiments, as illustrated in FIG. 13, an interface 1300 can be presented to the user to allow the user to edit the profile of the user's business. As shown, using interface 1300, the user can view and/or edit any suitable information about the user's business, such as the name and contact information (e.g., phone numbers, addresses, etc.) of the user's business, the awards and/or certificates that have been earned by the business, the business' affiliations, etc. The user can also enter a description of the business using interface 1300. In some embodiments, the description can be viewed by other users using the application. In addition, the user can upload a photo when creating a profile for the user's business.

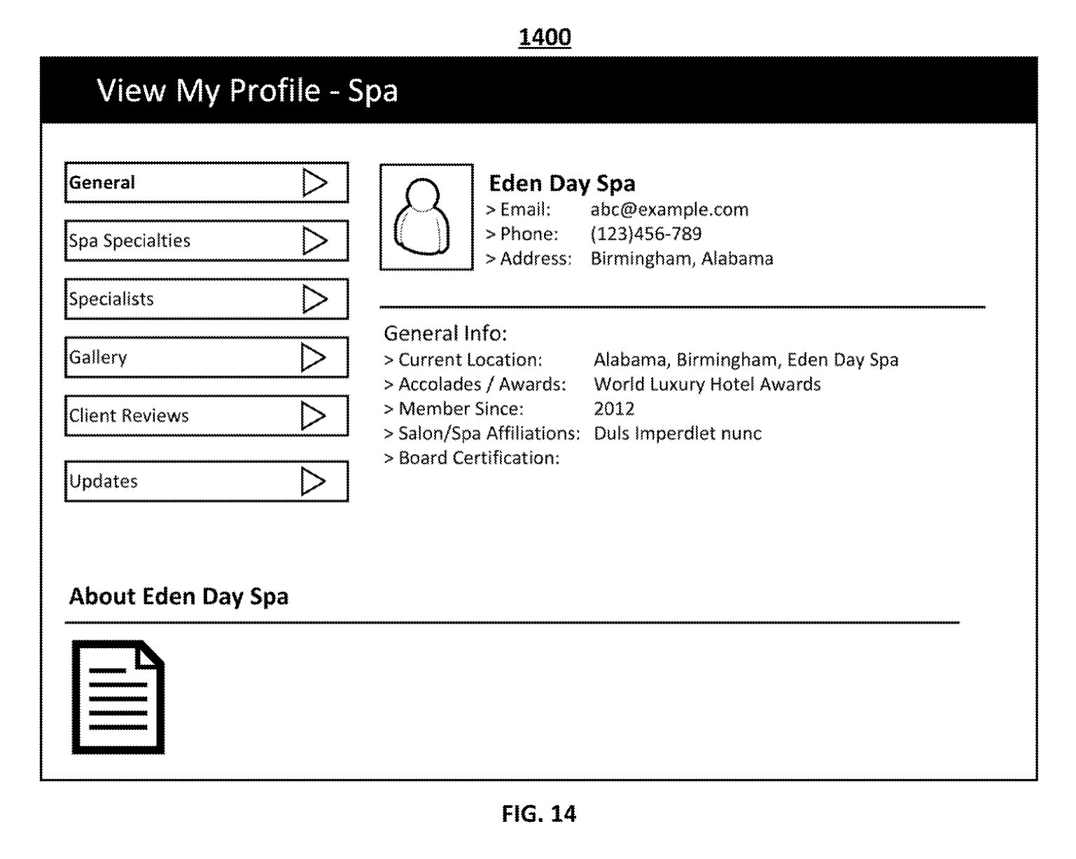

In some embodiments, the application can allow the user to browse the profile of the user's business using one or more suitable interfaces. For example, as illustrated in FIG. 14, interface 1400 can be presented to the user to allow the user to view the profile of the user's business. As shown, interface 1400 can include any suitable information about the user's business, such as one or more images of the user's business, a description of the user's business, the name and contact information (e.g., phone numbers, addresses, etc.) of the user's business, awards and/or certificates that have been earned by the business, the business' affiliations, etc. In some embodiments, the profile of the user's business can be viewed by other users using the application. In some embodiments, the user can post one or more job postings using the application.

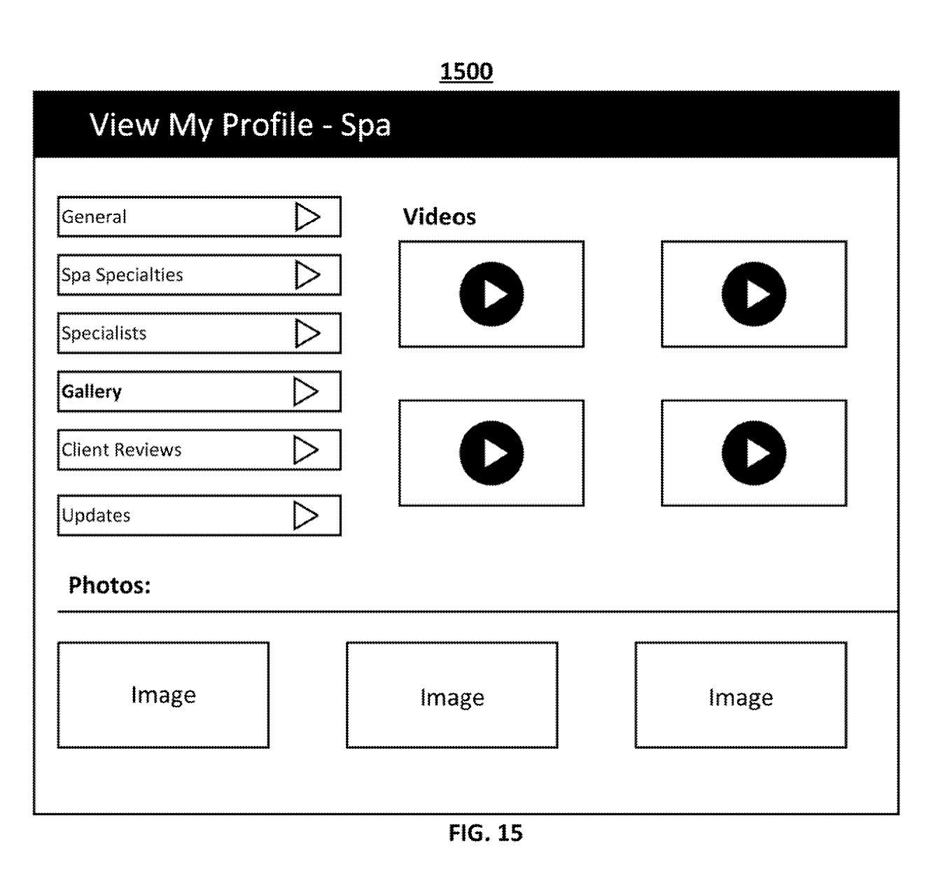

In some embodiments, as illustrated in FIG. 15, the application can allow the user to upload one or more videos, images about the products and/or services provided by the user or the user's business, or create links to one or more video/file sharing services that host such videos. In some embodiments, the photos and/or video clips uploaded and/or linked to by the user can be viewed by other users using the application.

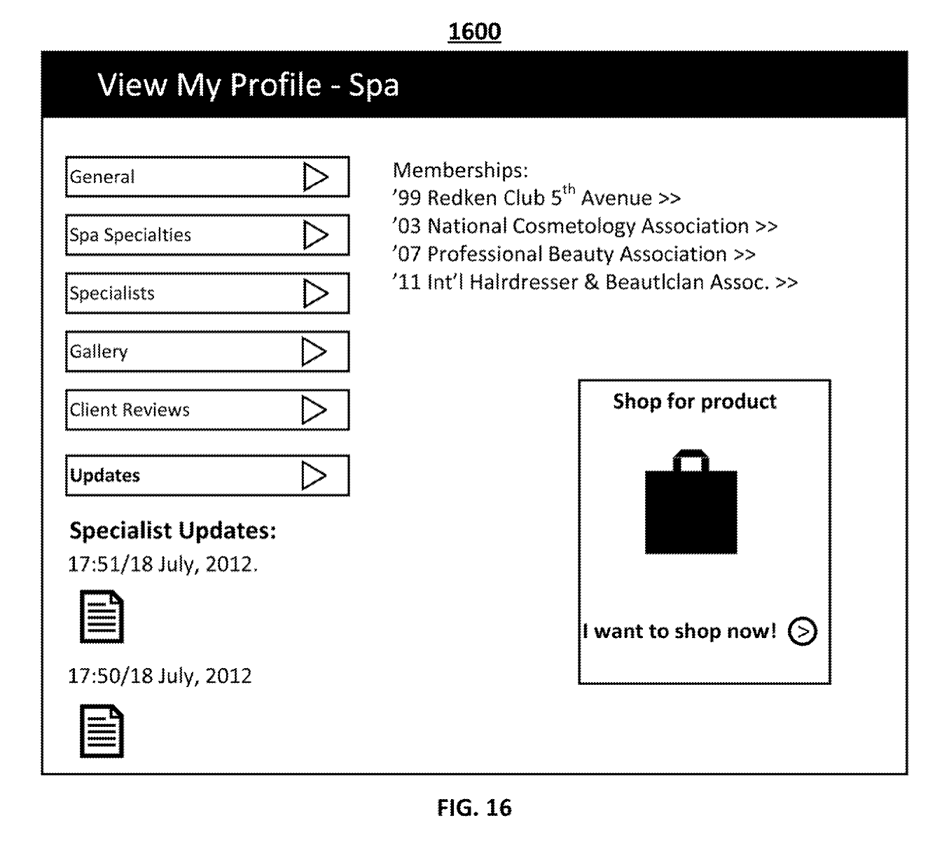

In some embodiments, as illustrated in FIG. 16, an interface 1600 can be presented to the user to allow the user to view and/or edit the memberships, affiliations, awards and other information about the user's business. In some embodiments, the user can also view and/or post news and other updates about the specialists, products, services, etc. of the user's business on interface 1600. In some embodiments, the user can send notifications about the news and updates (e.g., such as the opening of a new business) to other users using suitable user devices.

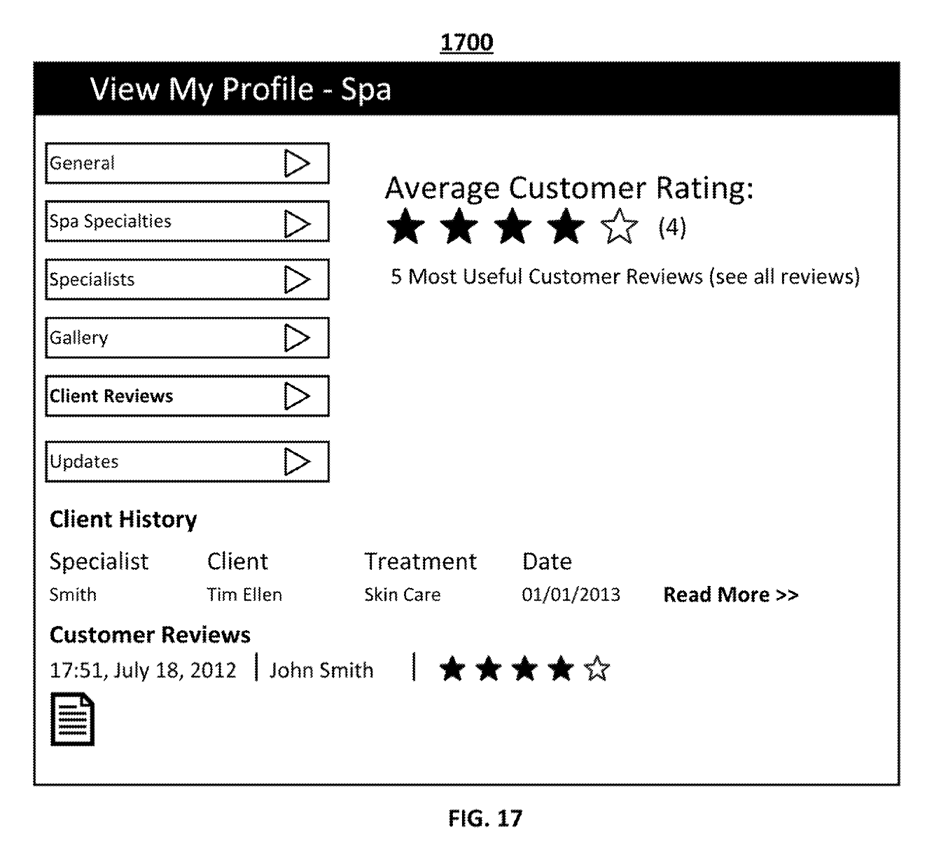

In some embodiments the application can allow the user to view customer ratings and/or customer comments relating to the user's business, products, services, etc. For example, as illustrated in FIG. 17, an interface 1700 can be presented to the user to allow the user to view client reviews. As shown, interface 1700 can include an average customer rating, comments made by other the user's clients regarding the user's services and/or products, and any other suitable information. In some embodiments, the user can rate the business, products, services, etc. of another user using the application. In some embodiments, interface 1700 can include information relating to past treatments, sessions, and/or any other suitable products and/or services provided to one or more clients of the user. In some embodiments, such information can include a description of a treatment, a date of a treatment, a specialist that provided the treatment, and/or any other suitable information relating to the treatments and/or sessions.

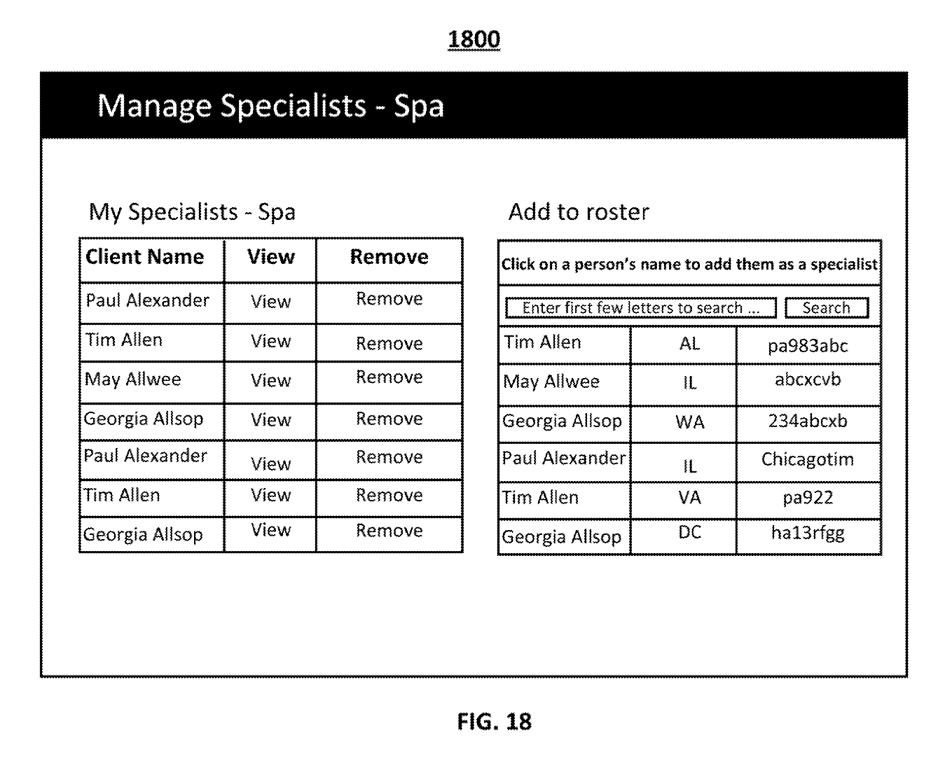

In some embodiments, the application can allow the user to manage information about one or more specialists associated with the user's business using one or more suitable interfaces. For example, as illustrated in FIG. 18, an interface 1800 can be presented to the user to allow the user to view and/or edit information about the specialists associated with the user's business. As shown, interface 1800 can include a list of the specialists associated with the user's business. In some embodiments, the user can select a specialist shown in the list to view detailed information about the specialist, such as the name of the selected specialist, the specialty of the selected specialist, the location of the selected specialist, the selected specialist's past employment history, the license(s) held by the selected specialist, etc.

In some embodiments, the application can allow the user to add information about one or more specialists associated with the user's beauty business to the user's account. For example, as illustrated in FIG. 18, interface 1800 can be presented to the user to prompt the user to add one or more specialists to the user's account. In some embodiments, the user can initiate a search for one or more specialists by entering suitable search terms (e.g., such as the specialty of the specialists, the names of the specialists, the location of the specialists, etc.). The application can then generated one or more search results based on the search terms and cause the search results to be presented on interface 1800. In some embodiments, the application can suggest a list of specialists in whom the user might be interested and cause the list to be displayed on interface 1800. The user can then select a specialist from the list of the suggested specialists and/or the search results and add the selected specialist to the user's account. In some embodiments, the user can view information relating to the specialists associated with the user's business (e.g., a spa, gym, salon, and/or any other suitable beauty business). For example, the user can view activities, comments, posts, and/or any other suitable information relating to active specialists associated with the user's business (e.g., such as specialists that are currently associated with the user's beauty business).

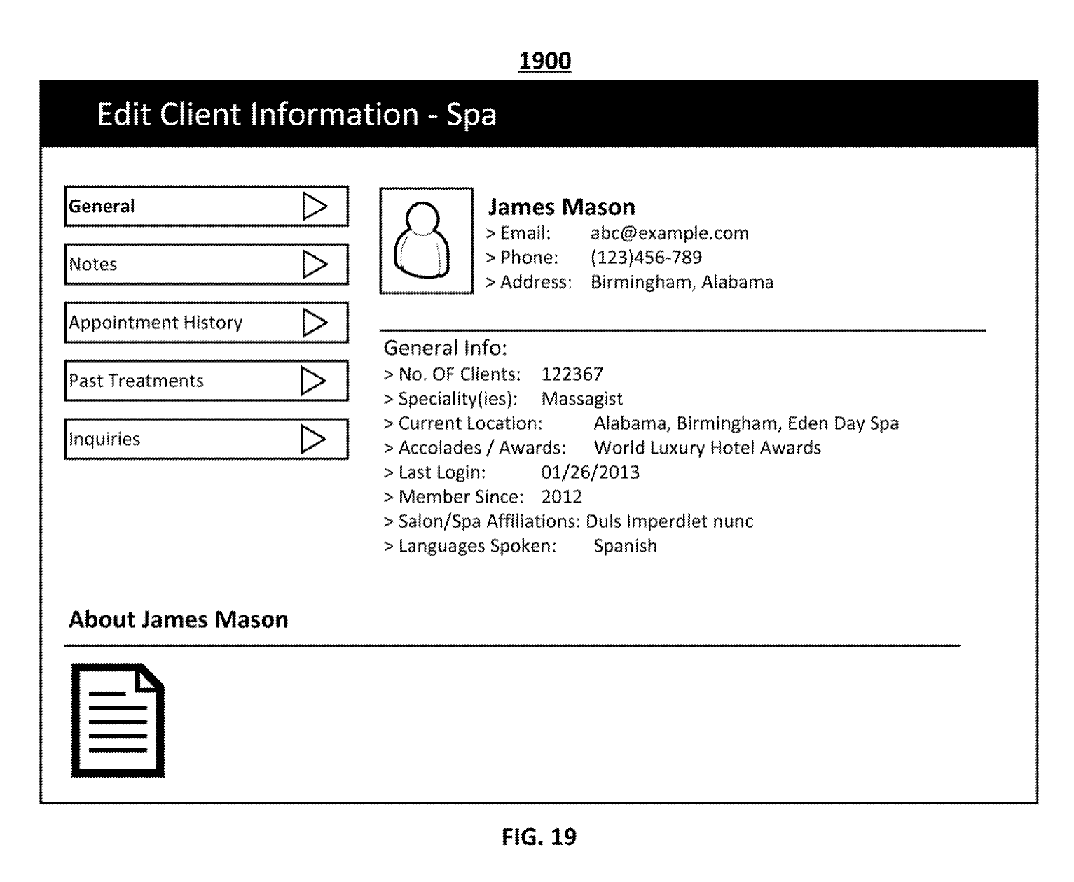

In some embodiments the application can allow the user to manage information about the user's clients using one or more suitable interfaces. For example, as illustrated in FIG. 19, an interface 1900 can be presented to the user to allow the user to view and/or edit information about one or more of the user's clients. More particularly, for example, interface 1900 can include information about a particular client, such as the name of the client, contact information of the client, history of past treatments, etc. In some embodiments, the user can edit the information displayed on interface 1900 in any suitable manner. In some embodiments, the user can create a new profile for a new client using one or more suitable interfaces. In some embodiments, the application can allow the user to extract information about one or more clients to one or more EXCEL spreadsheets.

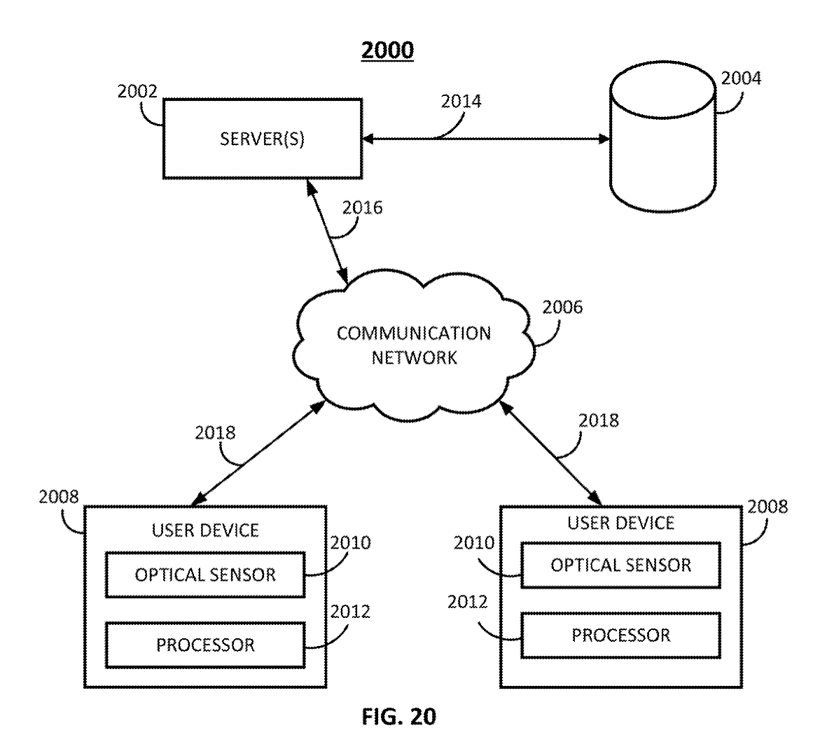

Turning to FIG. 20, a generalized block diagram of an example 2000 of a system for marketing beauty products and/or services in accordance with some implementations of the disclosed subject matter is shown. As illustrated, system 2000 can include one or more servers 2002, a database 2004, a communications network 2006, one or more user devices 2008, and communication links 2014, 2016, and 2018. In some embodiments, one or more of the interfaces illustrated in FIGS. 1-19 can be implemented using server(s) 2002 and/or user devices 2004.

Server(s) 2002 can be any suitable server for performing one or more portions of the mechanisms for marketing beauty products and/or services illustrated in FIGS. 1-19 and 21 and/or for performing any other suitable function. Server(s) 2002 can include and/or be any of a general purpose device such as a computer or a special purpose device such as a client, a server, etc. Any of these general or special purpose devices can include any suitable components, such as a hardware processor (which can be a microprocessor, a digital signal process, a controller, etc.), memory, communication interfaces, display controllers, input devices, etc.

Database 2004 can include any suitable device that can store information about nationwide specialists and/or businesses that can provide beauty products and/or services, such as names, addresses, specialties, and/or availabilities of the specialists and/or the businesses, information about clients of the specialists, and/or the businesses, and/or any other suitable information that can be used to market beauty products and/or services. In some embodiments, the specialists and the businesses can include pet groomers, makeup artists, hair stylists, laser therapy specialists, massage therapists, estheticians, nail technicians, fitness trainers, spas, beauty salons, hair salons, fitness centers, barber shops, and/or any other suitable specialist and/or business that can provide beauty products and/or services. In some embodiments, the information about the specialists and/or businesses can be indexed by specialty, product, service, availability, location, and/or any other suitable criterion or criteria.

User devices 2008 can include a mobile phone, a tablet computer, a laptop computer, a desktop computer, a personal data assistant (PDA), a portable email device, a gaming device, and/or any other suitable device. In some embodiments, as illustrated in FIG. 20, a user device 2008 can include an optical sensor 2010, a hardware processor 2012, and any other suitable components (e.g., such as memory, communication interfaces, display controllers, input devices, etc.). Optical sensor 2010 can be any suitable sensor that is capable of reading and/or scanning a barcode, such as a camera, a scanner, a barcode reader, etc. Processor 2012 can be any suitable hardware processor, such as a microprocessor, a digital signal processor, a controller, etc.

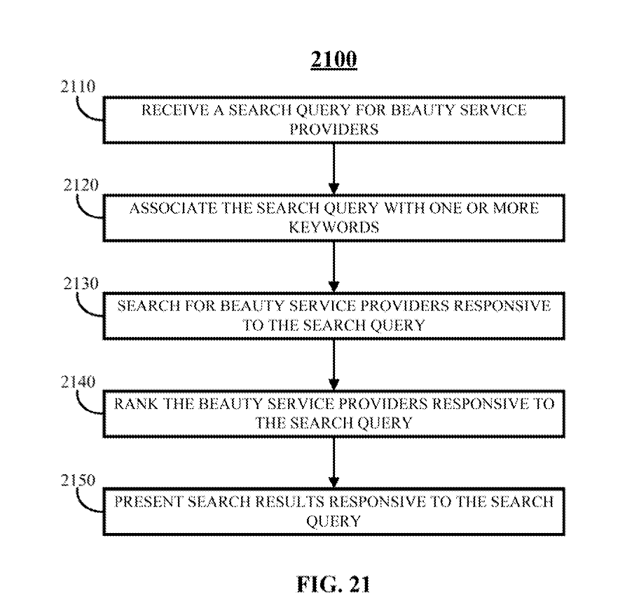

Although two user devices 2008 are shown in FIG. 21 to avoid over-complicating the drawing, any suitable number of these devices, and suitable types of these devices, can be used in some implementations.

Each of user devices 2008, server(s) 2002, and database 2004 can comprise a storage device, which can include a hard drive, a solid state storage device, a removable storage device, and/or any other suitable storage device. Server(s) 2002, database 2004, user devices 2008, optical sensor(s) 2010, and processor(s) 2012 can be located at any suitable location. Each of server(s) 2002, database 2004, user devices 2008, optical sensor(s) 2010, and processor(s) 2012 can be implemented as a stand-alone device or integrated with other components of system 2000.

Communications network 2006 can be any suitable computer network such as the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), a satellite network, a mobile phone network, a mobile data network, a cable network, a telephone network, a fiber optic network, and/or any other suitable communication network, or any combination of any of such networks.

Server(s) 2002 and user device(s) 2008 can be connected to communications network 2006 through communication links 2016 and 2018, respectively. In some embodiments, server(s) 2002 and database 2004 can be connected through communication link 2014. Communication links 2014, 2016, and 2018 can be any suitable communication links, such as network links, dial-up links, wireless links, hard-wired links, any other suitable communication links, or a combination of such links.

In some implementations, any suitable computer readable media can be used for storing instructions for performing the processes described herein. For example, in some implementations, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Turning to FIG. 21, a flow chart of an example 2100 of a process for marketing beauty products and services is shown in accordance with some embodiments of the disclosed subject matter. In some embodiments, process 2100 can be implemented using one or more hardware processors, such as one or more hardware processors of server 2002 and/or user device 2008 of FIG. 20.

As illustrated, process 2100 can begin by receiving a search query for beauty service providers at 2110. In some embodiments, a beauty service provider can be a specialist, business, and/or any other suitable individual and/or entity that can provide a beauty product and/or a beauty service. For example, a beauty service provider can be a hair stylist, a laser therapy specialist, a massage therapist, an esthetician, a nail technician, a fitness trainer, a pet groomer, and/or any other suitable specialist that can provide one or more beauty products and/or beauty services. As another example, a beauty service provider can be a spa, a beauty salon, a hair salon, a fitness center, a barber shop, and/or any other suitable business that can provide one or more beauty products and/or beauty services.

In some embodiments, the search query can include any suitable number of words, phrases, sentences, numbers, and/or any other suitable search terms. In some embodiments, the search query can be received in any suitable manner. For example, the search query can be received through one or more request messages (e.g., HyperText Transfer Protocol (HTTP) requests) transmitted from a user device executing the application described above in connection with FIGS. 1-19.

In some embodiments, the search query can correspond to any suitable user input. For example, the search query can correspond to one or more search terms inputted by a user using a suitable user input device, such as a keyboard, a mouse, a remote control, a gesture recognition system, a microphone, etc. In a more particular example, as described above in connection with FIGS. 1, 2, and 4, the search query can be received using one or more suitable user interfaces presented by the application.

Next at 2120, process 2100 can associate the received search query with one or more keywords. In some embodiments, the search query can be processed in any suitable manner to be associated with the keywords. For example, process 2100 can parse the search query into multiple search terms using a suitable natural language processing algorithm. Process 2100 can then identify one or more keywords based on the search terms. In some implementations, process 2100 can identify each of the search terms as a keyword associated with the search query. Additionally or alternatively, process 2100 can identify a synonym, an acronym and/or any other suitable term relating to one or more of the search terms as a keyword.

In some embodiments, a keyword associated with the search query can correspond to any suitable information relating to beauty service providers responsive to the search query, such as the name of the beauty service providers, the location of the user that inputs the search query, the specialty of the beauty service providers, services and/or products that can be provided by the beauty service providers, a specific time at which services and/or products are to be provided by the beauty service providers, languages spoken by the beauty service providers, and/or any other suitable information.

At 2130, process 2100 can search for beauty service providers responsive to the search query. For example, process 2100 can access a database storing information about beauty service providers (e.g., database 2004 of FIG. 20) and identify beauty service providers that match the search query. In some embodiments, a beauty service provider can be regarded as being a match to the search query when information stored in association with the beauty service provider (e.g., locations, specialties, availabilities, etc.) include one or more of the keywords that are identified at 2120.

In some embodiments, at 2140, process 2100 can rank the beauty service providers responsive to the search query. The ranking can be performed based on any suitable criterion or criteria. For example, the beauty service providers that match the search query can be ranked by relevancy (e.g., based on the number of keywords associated with a particular beauty service provider), geographic location, popularity (e.g., click-through-rate), rating, availability, and/or any other suitable criterion or criteria. In some embodiments, process 2100 can select a set of the beauty service providers based on the ranking, such as a suitable number of top ranked beauty service providers, a suitable percentage of the top ranking beauty service providers, and/or any other suitable set of the matching beauty service providers.

At 2150, process 2100 can cause search results responsive to the search query to be presented to a user. The search results can include any suitable information about one or more of the beauty service providers that match the search query. For example, the search results can include the names of the beauty service providers, the contact information (e.g., phone numbers, addresses, email accounts, etc.) of the beauty service providers, specialties of the matching beauty service providers, licenses held by the beauty service providers, awards earned by the beauty service providers, and/or any other suitable information relating to the beauty service providers.

In some embodiments, the search results can be presented in any suitable manner. For example, the search results can be presented as a list of beauty service providers responsive to the search query. In a more particular example, as described above in connection with FIG. 4, an interface 400 can be used to present names, specialties, locations, and/or any other suitable information relating to beauty service providers responsive to a search query. As another example, information about a particular matching beauty service provider can be presented using one or suitable user interfaces in the form of text, graphics, images, video, sounds, audio, and/or any other suitable content. In a more particular example, an interface 300 as shown in FIG. 3 can be used to present information about a matching beauty service provider in some embodiments.

It should be noted that the above steps of the flow diagram of FIG. 21 can be executed or performed in any order or sequence not limited to the order and sequence shown and described in the figure. Also, some of the above steps of the diagram of FIG. 21 can be executed or performed substantially simultaneously where appropriate or in parallel to reduce latency and processing times. Furthermore, it should be noted that the diagram of FIG. 21 is provided as an example only. At least some of the steps shown in this figure may be performed in a different order than represented, performed concurrently, or altogether omitted.

The provision of the examples described herein (as well as clauses phrased as “such as,” “e.g.,” “including,” and the like) should not be interpreted as limiting the disclosed subject matter to the specific examples; rather, the examples are intended to illustrate only some of many possible aspects.

Accordingly, methods, systems, and media for marketing beauty products and/or services are provided.

Although the disclosed subject matter has been described and illustrated in the foregoing illustrative implementations, it is understood that the present disclosure has been made only by way of example, and that numerous changes in the details of implementation of the disclosed subject matter can be made without departing from the spirit and scope of the disclosed subject matter, which is limited only by the claims that follow. Features of the disclosed implementations can be combined and rearranged in various ways.

What is claimed is:

1. A system for marketing beauty products and services, the system comprising:
at least one hardware processor that is configured to:
receive, from a first user device associated with a beauty service provider, a set of credentials associated with the beauty service provider;
retrieve, from a database, a profile associated with the beauty service provider in response to receiving the set of credentials, wherein the database stores information about beauty service providers and wherein the beauty service providers comprise specialists and businesses that provide at least one of a beauty product and a beauty service;
cause the profile associated the beauty service provider to be presented on the first user device;
receive, from the first user device, a plurality of images corresponding to a plurality of beauty products;
receive, from the first user device, at least one video corresponding to creating a makeover using at least one of the plurality of beauty products;
receive, from the first user device, at least one specialist tip relating to the beauty service provider;
store, in the database, the plurality of images, the video, and the specialist tip in association with the profile associated with the beauty service provider;
receive, from a second user device associated with a user, a search query including at least one keyword relating to the beauty service provider;
identify the beauty service provider based on the received keyword;
cause the plurality of images, the video, and the specialist tip to be presented on the second user device;
receive, from the second user device, a first image of the user;
generate a second image of the user by applying a makeover to the first image using at least one of the plurality of beauty products; and
cause the second image to be presented on the second user device.

2. The system of claim 1, wherein the specialists include at least one of a pet groomer, a hair stylists, a laser therapy specialist, a massage therapist, an esthetician, a nail technician, a makeup artist, and a fitness trainer.

3. The system of claim 1, wherein the businesses include at least one of a beauty salon, a hair salon, a fitness center, and a barber shop.

4. The system of claim 1, wherein the information about the beauty service providers comprises specialties, locations, and affiliations associated with the beauty service providers.

5. The system of claim 1, wherein the information about the beauty service providers comprises client profiles of the beauty service providers.

6. The system of claim 1, wherein the information about the beauty service providers comprises past treatments and sessions provided to clients of the beauty service providers.

7. The system of claim 1, wherein the hardware processor is further configured to:
receive, from a user device associated with a beauty service provider, a request for information relating to specialists associated with the beauty service provider; and
cause information relating to comments and activities associated with the specialists to be presented to the beauty service provider.

8. A method for marketing beauty products and services, the method comprising:
receiving, from a first user device associated with a beauty service provider, a set of credentials associated with the beauty service provider;
retrieving, from a database, a profile associated with the beauty service provider in response to receiving the set of credentials, wherein the database stores information about beauty service providers and wherein the beauty service providers comprise specialists and businesses that provide at least one of a beauty product and a beauty service;
causing the profile associated the beauty service provider to be presented on the first user device;
receiving, from the first user device, a plurality of images corresponding to a plurality of beauty products;
receiving, from the first user device, at least one video corresponding to creating a makeover using at least one of the plurality of beauty products;
receiving, from the first user device, at least one specialist tip relating to the beauty service provider;
storing, in the database, the plurality of images, the video, and the specialist tip in association with the profile associated with the beauty service provider;
receiving, from a second user device associated with a user, a search query including at least one keyword relating to the beauty service provider;
identifying, using a hardware processor, the beauty service provider based on the received keyword;
causing the plurality of images, the video, and the specialist tip to be presented on the second user device;
receiving, from the second user device, a first image of the user;
generating a second image of the user by applying a makeover to the first image using at least one of the plurality of beauty products; and
causing the second image to be presented on the second user device.

9. The method of claim 8, wherein the specialists include at least one of a pet groomer, a hair stylists, a laser therapy specialist, a massage therapist, an esthetician, a nail technician, a makeup artist, and a fitness trainer.

10. The method of claim 8, wherein the businesses include at least one of a beauty salon, a hair salon, a fitness center, and a barber shop.

11. The method of claim 8, wherein the information about the beauty service providers comprises specialties, locations, and affiliations associated with the beauty service providers.

12. The method of claim 8, wherein the information about the beauty service providers comprises client profiles of the beauty service providers.

13. The method of claim 8, wherein the information about the beauty service providers comprises past treatments and sessions provided to clients of the beauty service providers.

14. The method of claim 8, further comprising:
receiving, from a user device associated with a beauty service provider, a request for information relating to specialists associated with the beauty service provider; and
causing information relating to comments and activities associated with the specialists to be presented to the beauty service provider.

15. A non-transitory computer-readable medium containing computer-executable instructions that, when executed by a processor, cause the processor to perform a method for marketing beauty products and services, the method comprising:
receiving, from a first user device associated with a beauty service provider, a set of credentials associated with the beauty service provider;
retrieving, from a database, a profile associated with the beauty service provider in response to receiving the set of credentials, wherein the database stores information about beauty service providers and wherein the beauty service providers comprise specialists and businesses that provide at least one of a beauty product and a beauty service;
causing the profile associated the beauty service provider to be presented on the first user device;
receiving, from the first user device, a plurality of images corresponding to a plurality of beauty products;
receiving, from the first user device, at least one video corresponding to creating a makeover using at least one of the plurality of beauty products;
receiving, from the first user device, at least one specialist tip relating to the beauty service provider;
storing, in the database, the plurality of images, the video, and the specialist tip in association with the profile associated with the beauty service provider;
receiving, from a second user device associated with a user, a search query including at least one keyword relating to the beauty service provider;
identifying the beauty service provider based on the received keyword;
causing the plurality of images, the video, and the specialist tip to be presented on the second user device;
receiving, from the second user device, a first image of the user;
generating a second image of the user by applying a makeover to the first image using at least one of the plurality of beauty products; and
causing the second image to be presented on the second user device.

16. The non-transitory computer-readable medium of claim 15, wherein the specialists include at least one of a pet groomer, a hair stylists, a laser therapy specialist, a massage therapist, an esthetician, a nail technician, a makeup artist, and a fitness trainer.

17. The non-transitory computer-readable medium of claim 15, wherein the businesses include at least one of a beauty salon, a hair salon, a fitness center, and a barber shop.

18. The non-transitory computer-readable medium of claim 15, wherein the information about the beauty service providers comprises specialties, locations, and affiliations associated with the beauty service providers.

19. The non-transitory computer-readable medium of claim 15, wherein the information about the beauty service providers comprises client profiles of the beauty service providers.

20. The non-transitory computer-readable medium of claim 15, wherein the information about the beauty service providers comprises past treatments and sessions provided to clients of the beauty service providers.

21. The non-transitory computer-readable medium of claim 15, wherein the method further comprises:
receiving, from a user device associated with a beauty service provider, a request for information relating to specialists associated with the beauty service provider; and
causing information relating to comments and activities associated with the specialists to be presented to the beauty service provider.
